(19) United States
(12) Patent Application Publication
(10) Pub. No.: US 2003/0176551 A1
(43) Pub. Date: Sep. 18, 2003

(54) Stabilized pigmented polymer compositions

(76) Inventors: James E. Rediske, Moon Township, PA (US); Terry A. Potter, Beaver, PA (US)

Correspondence Address: BAYER CHEMICALS CORPORATION, 100 BAYER ROAD, PITTSBURGH, PA, 15205, US

(21) Appl. No.: 10/092,084

(22) Filed: Mar. 6, 2002

(51) Int. Cl. C08K 3/18

(52) U.S. Cl. 524/432

(57) ABSTRACT

The present invention relates to a composition containing A) a polymer, B) a pigment or a dye and C) ZnO as a stabilizer, wherein the initial CIELab value ΔE of the stabilized pigmented polymer is less than 10 compared to the pigmented polymer and the reduction of ΔE of the stabilized pigmented polymer after 750 kj UV radiation is at least 10 % compared to the pigmented polymer.

### BACKGROUND OF THE INVENTION

1. Field of the Invention

The invention relates to the stabilization of pigmented polymer compositions against UV-radiation.

1. Description of the Prior Art

Nearly all polymers degrade under the influence of UV-radiation. Many attempts have been made to stabilize polymers to enhance their useful life under the influence of UV-radiation.

The pigment zinc oxide has long been known to have UV-stabilizing properties in polymers.

Margosiak and coworkers disclose that carbon black is the best pigment to provide UV protection. Zinc oxide is reported to be a low cost inorganic pigment and can provide ultraviolet protection for plastics. It allegedly provides opaque formulations and better results with smaller particle sizes. The best solution is quoted as polypropylene containing 10% by weight of 0.11 μ ZnO (Modern Plastics, January 1969, page 114-116), (Modern Plastics, May 1970, page 115-122). Their best results were later found with synergystic combinations of 2% by weight of ZnO and 1% by weight of ethyl zimate, polygard, or dilauryl thiopropionate (Modern Plastics, May 1970, page 115-122; and October 1971, pages 160-161).

U.S. Pat. No. 4,680,204 discloses a coating for substrates containing substantially colorless, substantially inorganic microparticles of silica stably dispersed in a basecoat. A pigmented topcoat is applied thereafter.

EP 946 651 discloses a UV light absorber comprising particles of silicon compounds with a stoichiometric excess of silicon. The particles are surrounded by an oxide layer having a thickness of 1 to 300 nm which can additionally comprise more oxides of iron, titanium, cerium, tungsten, tin, and/or zinc. The UV light absorber can be incorporated in a matrix further comprising a plastic, coating, lacquer, paint, wood cosmetic, and/or glass.

JP (Kokai) 2-208369 discloses plastic, paint, or ink containing and UV-absorbing inorganic pigment having as an effective component zinc oxide with a surface area of 20 m²/g or higher. Favorable light transmission and UV absorbance are solely attributed to the surface area of the zinc oxide.

WO 00/50504 discloses a plastic composite containing at least one oxide of Ti, Zn, Sn, W, Mo, Ni, Wi, Ce, In, Hf, Fe with an average particle size of less than 100 nm.

EP 665265 discloses compositions comprising polymers and metal particles with a diameter of less than 100 nm and a particulate carrier metal.

EP 767 196, believed to correspond to WO 95/33787, discloses a thermoplastic resin film containing a mixture of silica and at least one other inorganic oxide other than silica having a haze value of 5% or less wherein the film is produced in a special process at a pH of 9 or above.

WO 96/09348 discloses polymers with pesticide resistance and light stability containing micronized zinc oxide with particle diameters from 10-200 nm and alkylated amine as light stabilizer.

The application with the internal code MO 6987, filed in parallel, also describes pigmented polymer compositions, that are stabilized by ZnO.

None of the publications discloses zinc oxide as UV stabilizer in a pigmented or dyed plastic with the properties currently claimed.

In fact, very little is known about the color value retention by stabilization of organic pigments. It is often assumed that the pigment itself is the UV-light stabilizer and is itself not subject to deterioration.

In many applications for plastics ranging from automobiles to toys it is very important that fading of the pigment is to be avoided. A further problem is the compatibility of the pigments and stabilizers with the plastic.

It was therefore an object of the present invention to provide pigmented or dyed plastic with enhanced UV resistance.

### SUMMARY OF THE INVENTION

The present invention relates to a composition containing A) a polymer, B) a pigment or a dye and C) ZnO as a stabilizer, wherein the initial CIELab value ΔE of the stabilized pigmented polymer is less than 10 compared to the pigmented polymer and the reduction of ΔE of the stabilized pigmented polymer after 750 kj UV radiation is at least 10% compared to the pigmented polymer.

### DETAILED DESCRIPTION OF THE INVENTION

Particularly suitable polymers are macromolecular materials, especially synthetically produced macromolecular substances. Examples of synthetic macromolecular substances include plastic materials, such as polyvinyl chloride, polyvinyl acetate, and polyvinyl propionate; polyolefins, such as polyethylene and polypropylene; high molecular weight polyamides; polymers and copolymers of acrylates, methacrylates, acrylonitrile, acrylamide, butadiene, or styrene; polyurethanes; and polycarbonates. Other suitable macromolecular substances include those of a natural origin, such as rubber and cellulose; those obtained by chemical modification, such as acetyl cellulose, cellulose butyrate, or viscose; or those produced synthetically, such as polymers, polyaddition products, and polycondensates.

Preferred materials include polyvinyl chloride and the polyolefins like polyethylene and polypropylene.

The materials containing the composition of the invention can have any desired shape or form, including molded articles, films, and fibers.

Suitable organic pigments according to the present invention include quinacridone pigments, perylene pigments, isoindoline pigments, carbazole pigments, anthraquinone pigments as well as other known organic pigments. Mixtures, including solid solutions, of such pigments are also suitable.

Perylene pigments, particularly the diimides and dianhydrides of perylene-3,4,9,10-tetracarboxylic acid, are also particularly suitable organic pigments. Suitable perylene pigments can be unsubstituted or substituted (for example, with one or more alkyl, alkoxy, halogens such as chlorine, or other substituents typical of perylene pigments), including those that are substituted at one or more imide nitrogen atoms with chemical groups such as alkyl. Crude perylenes can be prepared by methods known in the art. E.g., W. Herbst and K. Hunger, Industrial Organic Pigments, 2nd ed. (New York: VCH Publishers, Inc., 1997), pages 9 and 476-479; H. Zollinger, Color Chemistry (VCH Verlagsgesellschaft, 1991), pages 227-228 and 297-298; and M. A. Perkins, “Pyridines and Pyridones” in The Chemistry of Synthetic Dyes and Pigments, ed. H. A. Lubs (Malabar, Fla.: Robert E. Krieger Publishing Company, 1955), pages 481-482.

Quinacridone pigments are particularly suitable organic pigments.

Quinacridones (which, as used herein, includes unsubstituted quinacridone, quinacridone derivatives, and solid solutions thereof) can be prepared by any of several methods known in the art but are preferably prepared by thermally ring-closing various 2,5-dianilinoterephthalic acid precursors in the presence of polyphosphoric acid. E.g., W. Herbst and K. Hunger, Industrial Organic Pigments, 2nd ed. (New York: VCH Publishers, Inc., 1997), pages 454-461; S. S. Labana and L. L. Labana, “Quinacridones” in Chemical Review, 67, 1-18 (1967); and U.S. Pat. Nos. 3,157,659, 3,256,285, 3,257,405, and 3,317,539.

Suitable quinacridone pigments can be unsubstituted or substituted (for example, with one or more alkyl, alkoxy, halogens such as chlorine, or other substituents typical of quinacridone pigments). Isoindoline pigments, which can optionally be symmetrically or unsymmetrically substituted, are also suitable organic pigments and can be prepared by methods known in the art. E.g., W. Herbst and K. Hunger, Industrial Organic Pigments (New York: VCH Publishers, Inc., 1993), pages 398-415. A particularly preferred isoindoline pigment, Pigment Yellow 139, is a symmetrical adduct of iminoisoindoline and barbituric acid precursors.

Dioxazine pigments (that is, triphenedioxazines) are also suitable organic pigments and can be prepared by methods known in the art. E.g., W. Herbst and K. Hunger, Industrial Organic Pigments (New York: VCH Publishers, Inc., 1993), pages 534-537. Carbazole Violet 23 is a particularly preferred dioxazine pigment.

Other suitable organic pigments include 1,4-diketopyrrolopyrroles, anthrapyrimidines, anthanthrones, flavanthrones, indanthrones, iso-indolinones, perinones, pyranthrones, thioindigos, 4,4′-diamino-1,1′-dianthraquinonyl, and azo compounds, as well as substituted derivatives of these pigments.

Carbazole violet pigments are also suitable pigments.

Usually the crude pigments undergo one or more additional finishing steps that modify particle size, particle shape, and/or crystal structure in such a way that provides good pigmentary quality. See, for example, K. Merkle and H. Schäffer, “Surface Treatment of Organic Pigments” in Pigment Handbook, Vol. III (New York: John Wiley & Sons, Inc., 1973), page 157-167; R. B. McKay, “The Development of Organic Pigments with Particular Reference to Physical Form and Consequent Behavior in Use” in Rev. Prog. Coloration, 10, 25-32 (1979); and R. B. McKay, “Control of the application performance of classical organic pigments” in JOCCA, 89-93 (1989).

The invention is found to work best but is not limited to azo type pigments, (ex; Pigment Red 48:2), carbazole violet pigments, (ex; Pigment Violet 23), and quinacridone type pigments, (ex; Pigment Violet 19).

The initial tinctorial strength and transparency of the pigment in the composition can also be affected by solvent treatment carried out by heating a dispersion of the pigment composition, often in the presence of additives, in a suitable solvent. Suitable solvents include organic solvents, such as alcohols, esters, ketones, and aliphatic and aromatic hydrocarbons and derivatives thereof, and inorganic solvents, such as water. Suitable additives include compositions that increase dispersibility, and reduce polymer viscosity, such as polymeric dispersants (or surfactants), e.g., U.S. Pat. Nos. 4,455,173; 4,758,665; 4,844,742; 4,895,948; and, 4,895,949.

During that optional conditioning step, it is often desirable to use various other optional ingredients that provide improved properties. Examples of such optional ingredients include fatty acids having at least 12 carbon atoms, such as stearic acid or behenic acid, or corresponding amides, esters, or salts, such as magnesium stearate, zinc stearate, aluminum stearate, or magnesium behenate; quaternary ammonium compounds, such as tri[(C₁-C₄ alkyl)benzyl]ammonium salts; plasticizers, such as epoxidized soya bean oil; waxes, such as poly-ethylene wax; resin acids, such as abietic acid, rosin soap, hydrogenated or dimerized rosin; C₁₂-C₁₈-paraffin-disulfonic acids; alkylphenols; alcohols, such as stearyl alcohol; amines, such as laurylamine or stearylamine; and aliphatic 1,2-diols, such as dodecane-1,2-diol. Such additives can be incorporated in amounts ranging from about 0.05 to 20% by weight (preferably 1 to 10% by weight) based on the amount of pigment.

There are several ways known to produce ZnO. It was found that often the degree of improvement of color retention is dependent upon the particle size distribution of the ZnO employed in the formulation. Smaller particle size could often be found to provide improved color retention.

Definition of ΔE

Color evaluations can be performed using a Gretag MacBeth Coloreye 7000A using Propallete 4.1 color software. The color can be evaluated by CIELab* and CIELCh with 10 degree observer, D65 illuminant, large area view, spectral component included, and spherical geometry.

One feature of the present invention is to improve the lightfast characteristics of organic pigments that deteriorate under accelerated weathering conditions. Color retention or deterioration can be measured by the ΔE parameter under the above color measurement conditions.

The degree of improvement of color retention after 750 kj UV radiation for the pigmented polymer stabilized with ZnO should be at least 10%, preferably at least 25%, more preferably at least 30%, and most preferably at least 50% compared to the pigmented polymer for an equivalent period of exposure. The best mixtures showed an improvement of at least 75% compared to the unstabilized pigmented polymer. In other words a sample that exhibits a ΔE of 10.0 in 6 weathering cycles is considered to have benefited from the invention if the ΔE of the improved sample is 9 units maximum, preferably 7.5 units maximum.

The function of the invention is generally independent of the manner in which the additive is incorporated into the matrix.

For mixing compounds B) and C) the pigment can be dried for use or for further conditioning, for example, by milling.

Suitable milling methods include dry-milling methods, such as jet milling, ball milling, and the like, and wet-milling methods, such as salt kneading, sand milling, bead milling, and the like in water or organic liquids (such as alcohols or esters), with or without additives. Milling can be carried out using additives such as inorganic salts (especially for dry milling) and surfactants or dispersants. Suitable milling liquids for wet milling include organic liquids, such as alcohols, esters, ethers, ketones, and aliphatic or aromatic hydrocarbons and derivatives thereof, and inorganic liquids, such as water.

Mixing of components A), B), and C) is usually performed by suitable methods known in the art, particularly in an extruder, a banbury mixer, a two-roll mixer, or a high-speed mixer.

The ratio of stabilizer to pigment usually is between 1:1 and 10:1, preferably 2.5:1 and 7.5:1 more preferably 2.5:1 and 5:1.

The composition of polymer and stabilizer usually contains between 0.01 and 0.5% wt %, preferably 0.1 and 0.5 wt. % and more preferably 0.15 and 0.3 wt. % pigment based on the wole composition.

The plastic can contain 0.5 to 2.5 wt % of other stabilizers based on the plastic.

Further ingredients are additives common in pigment and polymer compositions.

The polymers can also contain plasticizers, dispersing and wetting agents known in the art.

### EXAMPLES

The dispersion of the pigment and zinc oxide was accomplished by means of a two-roll mill at a temperature sufficient to promote fluxing of the thermoplastic resin (PVC). The pigment and metal oxide were charged simultaneously to the mill and co-dispersed in the plastic. The colored plastic was then sheeted off the mill, processed to sheets and tested for accelerated weathering.

1.1 Formulations

1.1.1 All tests were performed using the following formulations for all pigments.

| | A | B | C | D |
|---|---|---|---|---|
| Pigment | 0.2% | 0.2% | 0.2% | 0.2% |
| UV Abs. | 0.0% | 0.5% | 1.0% | 2.5% |
| Resin | 99.8% | 99.3% | 98.8% | 97.3% |

1.1.2 Pigment I=P1=Pigment Red 48:2

1.1.3 Pigment 2=P2=Bayplast Yellow G (Bayer Corporation)

1.1.4 Pigment 3=P3=Pigment Blue 15:3

1.1.5 Pigment 4=P4=Pigment Violet 19

1.1.6 Pigment 5=P5=Pigment Red 123

1.1.7 Pigment 6=P6=Violet 23

1.1.8 Pigment 8=P8=Pigment Red 202

1.1.9 Pigment 9=P9=Pigment Yellow 139

1.1.10 Pigment 10=P10=Pigment Yellow 150

1.1.11 UV Absorber 1=Uval=ZnO particle size (psz)=25-50 nm

1.1.12 UV Absorber 2=Uva2=ZnO psz <25 nm

1.1.13 UV Absorber 3=Uva3=ZnO psz >50 nm

1.1.14 UV Absorber 4=Uva4=ZnS psz=25-50 nm

1.1.15 UV Absorber 5=Uva5=ZnS psz <25 nm

1.1.16 UV Absorber 6=Uva6=ZnS psz >50 nm

1.1.17 UV Absorber 7=Uva7=TiO2 psz=25-50 nm

1.1.18 UV Absorber 8=Uva8=TiO2 psz <25 nm

1.1.19 UV Absorber 9=Uva9=TiO2 psz >50 nm

1.1.20 Resin 1=R1=flexible PVC (fPVC)

1.1.21 Resin 2=R2=low-density polyethylene (LDPE)

1.1.22 Resin 3=R3=polystyrene (PS)

1.2 All pigment and UV absorber quantities were weighed to +/−0.0002 g on an analytical balance.

1.3 Resin was weighed to +/−0.02 g on a top loading balance.

2.0 Dispersion

2.1 In all cases the resin was charged to the nip of a two roll mill which had been preheated to 328 degrees F. on the front roll and 325 degree F. for the back. The resin was allowed to preheat for between 3 and 5 minutes.

2.2 The mill nip was set to about 0.03 inches and the mill started. This resulted in the banding of the resin to the mill. As the banding took place the nip was slowly increased first to about 0.045″ and then finally to about 0.06″.

2.3 After all of the resin was banded and the mill gap had been adjusted to 0.06″ the pigment and UV absorber were added simultaneously to the plastic and a timer started for a 5 minute countdown. Any pigment or UV absorber that fell through the mill nip was added back into the banded plastic.

2.4 During the milling the plastic was worked back and forth on the mill once every 30 seconds. Working the plastic first in one direction and allowing the mill to redistribute the mixture, and then 30 seconds later, working the mixture the opposite direction and allowing the mill to redistribute. This process was continued for the entire 5 minutes.

2.5 At the end of the five minutes, the now colored plastic was removed from the two roll mill and allowed to cool to about room temperature.

2.6 The sheet of colored plastic was then taken to a second two-roll mill that was not heated. The nip gap was set at 0.01″ and the roller speeds were at a differential of 1:1.25 front to back.

2.7 The plastic sheet was folded once in the machine direction and then passed through the cold mill at right angles to the machine direction. After retrieving the sheet from the bottom of the rolls it was again folded once in the machine direction and passed again through the two-roll mill at right angles to the machine direction. This was done for a total of 12 passes.

2.8 After the cold milling the plastic sheet was then banded again to the hot two-roll mill at a gap setting of 0.06″ and worked back and forth as above for three minutes. With about 30 seconds remaining before the completion of the 3 minutes, the mill gap was closed to the original 0.03″ and allowed to distribute evenly.

2.8.1 At the end of the 3 minutes the plastic was removed from the mill and allowed to cool to room temperature.

2.8.2 All samples for a particular pigment were completed in this manner before proceeding to the next step.

3.0 Color

3.1 Color was read using CIELab* and CIELCH, with spherical geometry, spectral component included, 10 degree observer, large area view and with D-65 and C illuminants.

3.2 The specific hardware and software for this experiment were a MacBeth Coloreye 7000A with Optiview 2.0 software.

3.3 In all cases the formula without the UV absorber was read as the standard.

3.4 The color of all samples was then read to demonstrate the difference imparted by the individual UV absorbers at the various loadings. This differential was the basis for judging the performance of the absorbers after weathering.

4.0 Weathering

4.1 Accelerated weathering testing was performed in an Atlas Ci35A Weatherometer in accordance with SAE J1885.

4.2 For one weathering cycle the material was exposed to 263 kj (kilojoules) of energy. One cycle was completed in 7 or 8 days.

4.3 Testing was carried out for a period of time so as to indicate significant differences in the performance of the pigment as indicated by the degree of color change.

4.3.1 Three possible end points were judged to have merit

4.3.1.1 Failure of the control color ΔE>10 units.

4.3.1.2 Ratio of ΔE control/ΔE sample >2.0

4.3.1.3 Completion of 6 weathering cycles, approximately 1500 kj.

4.4 All evaluations were made consistent with the color reading procedures in section 3.0 above.

5.0 Tabulation of Data

5.1 The ΔE of all weathered samples was determined relative to the unweathered control sample containing no UV absorber.

TABLE 1
IMPROVED LIGHTFASTNESS OF COLORED THERMOPLASTIC SUBSTRATES
*color data as measured against formula A to demonstrate formula starting color difference
**significant yellow discoloration of the substrate polymer
***polymer is effectively clear but not yet discolored

The experiments show that the stabilized polymer is transparent and
more resistant against radiation. The stabilization is dependent on the ZnO
level in the colored polymer.

| Formula | kJ exposure | dL* | da* | db* | dC* | dH* | dE |
|---|---|---|---|---|---|---|---|
| A,P1,R1 | 0 | — | — | STANDARD | — | — | — |
| Bayplast Red 2B | 789 | 45.27 | −42.994 | 7.988 | −21.107 | 38.299 | 62.942 |
| Ca mono azo | | | | | | | |
| Control | | | | | | | |
| B,P1,R1,UVA1 | | 0.243 | 0.031 | −1.638 | −0.72 | −1.472 | 1.657 |
| Bayplast Red 2B | 0 | — | — | STANDARD | — | — | |
| 0.5% ZnO | 789 | 7.322 | 12.475 | 2.793 | 12.485 | −2.749 | 14.732 |
| Ca mono azo | | | | | | | |
| C,P1,R1,UVA1 | | −0.338 | −1.774 | −4.196 | −3.453 | −2.971 | 4.568 |
| Bayplast Red 2B | 0 | — | — | STANDARD | — | — | — |
| 1.0% ZnO | 789 | 3.899 | 9.216 | 8.292 | 11.947 | 3.311 | 12.996 |
| Ca mono azo | | | | | | | |

Table 2: The experiments in the following tables show that the stabilized polymers are transparent and resistant against radiation and that it is of minor importance if the pigment is in powder form or granulated.

TABLE 2 a
Powdered pigment

| | | kJ | | | | | | |
|---|---|---|---|---|---|---|---|---|
| Formula | | exposure | dL* | da* | db* | dC* | dH* | dE |
| A,P4,R1 | * | | | | | | | |
| Bayplast Red 4B | | 0 | — | — | STANDARD | — | — | — |
| Control | | 789 | −1.808 | −3.358 | 2.966 | −1.894 | 4.06 | 4.831 |
| PV 19 | | | | | | | | |
| quinacridone | | | | | | | | |
| B,P4,R1,UVA1 | * | | −0.411 | −1.157 | 0.444 | −0.905 | 0.846 | 1.305 |
| Bayplast Red 4B | | 0 | — | — | STANDARD | — | — | — |
| 0.5% ZnO | | 789 | −1.196 | −2.121 | 0.26 | −1.852 | 1.067 | 2.449 |
| PV 19 | | | | | | | | |
| quinacridone | _________ | | | | | | | |
| C,P4,R1,UVA1 | * | | −0.593 | −2.102 | −1.796 | −2.61 | −0.911 | 2.827 |
| Bayplast Red 4B | | 0 | — | — | STANDARD | — | — | — |
| 1% ZnO | | 789 | −1.316 | −1.301 | 3.799 | 0.268 | 4.007 | 4.226 |
| PV 19 | | | | | | | | |
| quinacridone | | | | | | | | |

TABLE 2 b
Granulated pigment

| | | kJ | | | | | | |
|---|---|---|---|---|---|---|---|---|
| Formula | | exposure | dL* | da* | db* | dC* | dH* | dE |
| A,P4,R1,UVA1 | * | | | | | | | |
| Bayplast Red 4B | | 0 | — | — | STANDARD | — | — | — |
| Gr | | | | | | | | |
| Control | | 789 | −2.144 | −3.71 | 4.142 | −1.846 | 5.246 | 5.96 |
| PV 19 | | | | | | | | |
| quinacridone | | | | | | | | |
| B,P4,R1,UVA1 | * | | −0.926 | −2.162 | 0.714 | −1.77 | 1.432 | 2.458 |
| Bayplast Red 4B | | 0 | — | — | STANDARD | — | — | — |
| Gr | | | | | | | | |
| 0.5% ZnO | | 789 | −1.796 | −3.346 | −0.142 | −3.157 | 1.117 | 3.8 |
| PV 19 | | | | | | | | |
| quinacridone | | | | | | | | |
| C,P4,R1,UVA1 | * | | −0.5 | −1.676 | −0.323 | −1.685 | 0.276 | 1.779 |
| Bayplast Red 4B | | 0 | — | — | STANDARD | — | — | — |
| Gr | | | | | | | | |
| 1% ZnO | | 789 | −1.442 | −1.213 | 3.201 | 0.069 | 3.422 | 3.715 |
| PV 19 | | | | | | | | |
| quinacridone | | | | | | | | |

Table 3: The experiments in the following tables show that the stabilized polymers are transparent and resistant against radiation. The stabilization effect in pigments that are very lightfast in themselves is not of the same intensity, but still noticable

| | | kJ | | | | | | |
|---|---|---|---|---|---|---|---|---|
| Formula | | exposure | dL* | da* | db* | dC* | dH* | dE |
| A,P6,R1 | * | | | | | | | |
| Indofast Violet B | | 0 | — | — | STANDARD | — | — | — |
| 4018 | | | | | | | | |
| Control | | 789 | −0.999 | —1.461 | 0.317 | −1.214 | −0.872 | 1.798 |
| PV 23 | | | | | | | | |
| B,P6,R1,UVA1 | * | | 0.226 | −0.445 | 0.229 | −0.478 | −1.353 | 0.549 |
| Indofast Violet B | | 0 | — | — | STANDARD | — | — | — |
| 4018 | | | | | | | | |
| 0.5% ZnO | | 789 | −1.127 | −0.56 | −0.601 | 0.088 | −0.817 | 1.395 |
| PV 23 | | | | | | | | |

Table 4: The experiments show that the stabilized polymer is transparent and resistant against radiation and that the stabilization effect is slightly dependent on the ZnO particle size.

| | kJ | | | | | | |
|---|---|---|---|---|---|---|---|
| Formula | exposure | dL* | da* | db* | dC* | dH* | dE |
| A,P1,R1 | 0 | — | — | STANDARD | — | — | — |
| Bplst Red 2B | 789 | 24.002 | −11.184 | 29.612 | 11.789 | 29.376 | 39.725 |
| Gran | | | | | | | |
| Control | | | | | | | |
| | | −0.277 | 0.279 | −0.792 | −0.125 | −0.83 | 0.884 |
| B,P1,R1,UVA1 | 0 | — | — | STANDARD | — | — | — |
| Bplst Red 2B | 789 | 5.196 | 8.531 | 2.062 | 8.55 | −1.978 | 10.199 |
| Gran | | | | | | | |
| 0.5% nano-ZnO | | | | | | | |

Table 5: The experiments show that the stabilized polymer is transparent and resistant against radiation but that the stabilization effect is not dependent on the way the ZnO is introduced into the colored polymer. The following pigment/ZnO compositions are preblended and then added to the polymer. The stabilization is dependent on the amount of ZnO actually present in the overall mixture.

| | | kJ | | | | | | |
|---|---|---|---|---|---|---|---|---|
| Formula | | exposure | dL* | da* | db* | dC* | dH* | dE |
| A,P1,R1 | | | 39.835 | 48.364 | 25.112 | 54.495 | 27.44 | |
| Bayplast Red 2B | | 0 | — | — | STANDARD | — | — | — |
| Ca mono azo | | 789 | 16.018 | 6.966 | 24.625 | 19.904 | 16.086 | 30.191 |
| Control | | | | | | | | |
| C,P1,R1,UVA1 | * | | −0.369 | −0.522 | −1.709 | −1.236 | −1.291 | 1.825 |
| 0.7% HP Red 28 | | 0 | — | — | STANDARD | — | — | — |
| (0.5% ZnO) | | 789 | 4.768 | 9.96 | 8.24 | 12.637 | 2.72 | 13.777 |
| blndr | | | | | | | | |
| Ca mono azo | | | | | | | | |

Table 6: Preblend having a ratio ZnO/pigment of 5/1

| | | kJ | | | | | | |
|---|---|---|---|---|---|---|---|---|
| Formula | | exposure | dL* | da* | db* | dC* | dH* | dE |
| C,P1,R1,UVA1 | * | | −0.074 | −0.236 | −3.256 | −1.636 | −2.824 | 3.265 |
| 1.2% EHP Red | | 0 | — | — | STANDARD | — | — | — |
| 2B | | | | | | | | |
| (0.5% ZnO) | | 789 | 2.66 | 6.529 | 5.321 | 8.183 | 1.996 | 8.833 |
| blndr | | | | | | | | |
| Ca mono azo | | | | | | | | |

Table 7: These control experiments without colorant show that the stabilized polymer is transparent and resistant against radiation but that the stabilization effect is not only based on the stabilization of the polymer. There is a stabilization in the pigment itself (compared the composition of Table 1).

| | kJ | | | | | | |
|---|---|---|---|---|---|---|---|
| Formula | exposure | dL* | da* | db* | dC* | dH* | dE |
| A,N/A,R1,UVA1 | | | | | | | |
| NO COLORANT | 0 | 13 | — | STANDARD | — | — | — |
| Control | 789 | 0.205 | −0.278 | 0.156 | 0.187 | 0.258 | 0.379 |
| B,N/A,R1,UVA1 | | −1.438 | −0.464 | 1.451 | 1.495 | 4.875 | 2.36 |
| NO COLORANT | 0 | — | — | STANDARD | — | — | — |
| 0.5% ZnO | 789 | 1.125 | 0.196 | −0.102 | −0.127 | −0.181 | 1.146 |
| C,N/A,R1,UVA1 | | −1.361 | −1.212 | 1.701 | 1.91 | 13.504 | 3.43 |
| NO COLORANT | 0 | — | — | STANDARD | — | — | — |
| 1% ZnO | 789 | −0.176 | −0.178 | 1.33 | 1.327 | —0.203 | 1.354 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition comprising
A) a polymer,
B) a pigment or a dye, and
C) ZnO as a stabilizer,
wherein
(i) the initial CIELab value ΔE of the stabilized pigmented polymer is less than 10 compared to the pigmented polymer and
(ii) the reduction of ΔE of the stabilized pigmented polymer after 750 kj UV radiation is at least 10% compared to the pigmented polymer.

2. The composition of claim 1, wherein the reduction of ΔE is at least 50%.

3. The composition of claim 1, wherein the ratio of stabilizer to pigment is between 1:1 and 10:1.

4. The composition of claim 1, wherein the ratio of stabilizer to pigment is between 2.5:1 and 7.5:1.

5. The composition of claim 1, wherein the ratio of stabilizer to pigment is between 2.5:1 and 5:1.

6. The composition of claim 1, wherein the ZnO is present in 0.01 to 5 parts by weight based on the weight of A), B), and C).

7. The composition of claim 1, wherein the ZnO is present in 0.05 to 3 parts by weight based on the weight of A), B), and C).

8. The composition of claim 1, wherein the ZnO is present in 0.1 to 2 parts by weight based on the weight of A), B), and C).

9. The composition of claim 1, wherein the ZnO is present in 0.15 to 0.75 parts by weight based on the weight of A), B), and C).

10. The composition of claim 1, wherein compound B) is present in 0.01 to 0.5 parts by weight based on the weight of A), B), and C).

11. The composition of claim 1, wherein compound B) is present in 0.1 to 0.3 parts by weight based on the weight of A), B), and C).

12. The composition of claim 1, wherein compound B) is present in 0.15 to 0.25 parts by weight based on the weight of A), B), and C).

13. The composition of claim 1, wherein the ZnO has a particle size of 5 to 50 nm.

14. The composition of claim 1, wherein the ZnO has a particle size of 15 to 45 nm.

15. The composition of claim 1, wherein the ZnO has an particle size of 25 to 45 nm.

16. The composition of claim 1, wherein the ZnO has a average particle size of 30 to 40 nm.

17. The composition of claim 1, wherein the polymer is selected from the group consisting of polyvinyl chloride, polyethylene, and polypropylene.

18. The composition of claim 1, wherein compound B) is an organic pigment, a red iron oxide, or a dye.

19. The composition of claim 18, wherein the organic pigment is selected from the group of red pigments and violet pigments.

20. A process comprising the steps of dry mixing B) a pigment and C) ZnO.

21. A process comprising the step of dry mixing A) a polymer, B) a pigment and C) ZnO.

22. The process of claim 21 comprising the step of dry mixing A) a polymer, B) a pigment and C) ZnO in an extruder.

23. A masterbatch composition containing
95.5 to 50 parts by weight of a polymer A) and
0.5 to 50 parts by weight of a mixture of an organic pigment B) and ZnO as a stabilizer based on the weight of A), B), and C).

24. The composition of claim 23, wherein the ratio of stabilizer to pigment is between 1:1 and 10:1.

25. The composition of claim 23, wherein the ratio of stabilizer to pigment is between 2.5:1 and 7.5:1.

26. The composition of claim 23, wherein the ratio of stabilizer to pigment is between 2.5:1 and 5:1.
